(19) United States
(12) Patent Application Publication
(10) Pub. No.: US 2018/0007841 A1
(43) Pub. Date: Jan. 11, 2018

(54) COLLAPSIBLE AND EXPANDABLE HORTICULTURAL TRAY

(71) Applicant: Landmark Plastic Corporation, Akron, OH (US)

(72) Inventors: James T. GIBSON, Granville, OH (US); Steven P. MERZWEILER, Akron, OH (US)

(73) Assignee: Landmark Plastic Corporation, Akron, OH (US)

(21) Appl. No.: 15/645,035

(22) Filed: Jul. 10, 2017

Related U.S. Application Data
(60) Provisional application No. 62/359,714, filed on Jul. 8, 2016.

(51) Int. Cl. A01G 9/02; A01G 1/00; A01G 27/00; B65D 21/02

(52) U.S. Cl. CPC A01G 9/028; B65D 21/0206; A01G 1/001; A01G 9/026; A01G 27/00

(57) ABSTRACT

The present invention, in different embodiments, discloses a horticultural tray and a method of use thereof. The horticultural tray includes first and second elongate portions having one or more receptacles for growing medium, and a foldable elongate portion between the first and second elongate portions. The foldable elongate portion has a central hinge and sloped side portions that slope downward and away from the central hinge toward the first and second elongate portions. The foldable elongate portion also has side hinges disposed between the foldable elongate portion and the first and second elongate portions. The horticultural tray may also have a first locking tab and a second locking tab configured so that the first locking tab fits securely inside the second locking tab when the horticultural tray is in a collapsed configuration.

### CROSS-REFERENCE TO RELATED APPLICATIONS

This application claims priority to, and the benefit of, U.S. Provisional Patent Application No. 62/359,714, filed Jul. 8, 2016 with the U.S. Patent and Trademark Office, which is hereby incorporated by reference.

### FIELD OF THE INVENTION

This invention relates generally to horticultural standalone trays or sheets, which are insertable into a carrier tray or the like, and methods for using horticultural trays to grow plants, the horticultural trays each having a plurality of rows of one or more receptacles (“cells”) configured to receive growing medium or a pot.

### BACKGROUND

Presently, horticultural growers commonly use sheets, which are insertable into a carrier tray or the like, having a plurality of cells arranged in a plurality of rows. The rows are closely arranged so to maximize the quantity of cells and rows within the tray. In practice, the cells are filled with a growing medium, such as soil or compost, for example. This may be accomplished manually or by use of a machine. The growing medium may be loose or in the form of a plug (a compacted growing medium). The cell rows are separated from one another to forms strips of cells. This could be any combination of strips, such as single rows or two rows attached depending on intended plant genetics and growing requirements. This separation may be performed before or after the growing medium has been placed into the cells, and is commonly achieved by slicing or cutting the tray between adjacent cell rows. Seeds or plant cuttings are added to the growing medium within each cell before or after separation. Thereafter, the strips are spaced further apart to provide sufficient spacing between adjacent rows for proper growth of the plants within the cells. Often the strips are placed and spaced out in a separate carrier tray, since the strips lack sufficient structural integrity to permit proper handling. After a designated growth period, the strips will then be consolidated (multiple carrier trays of strips become one carrier tray of strips) for the next phase of production or shipment. Because the separation and even transportation of the strips requires additional processing and labor, which results in additional costs, there is a need to reduce and even eliminate these inefficiencies and defects.

### SUMMARY OF THE INVENTION

The present invention, in different embodiments, comprises a horticultural tray and a method of providing and using a horticultural tray for growing plants.

In particular embodiments of the horticultural tray, the horticultural tray comprises: a first elongate portion and a second elongate portion each comprising one or more receptacles configured to receive and retain plant growing medium, each of the one or more receptacles extending from an opening arranged along a top side of the tray, each of the receptacles extending depthwise away from the top side and toward a bottom side of the tray; a foldable elongate portion disposed between the first elongate portion and the second elongate portion, the foldable elongate portion comprising: a central hinge disposed along a center length of the foldable elongate portion; a first sloped side portion disposed between the central hinge and the first elongate portion and a second sloped side portion disposed between the central hinge and the second storage elongate portion, the first sloped side portion sloping downward and away from the central hinge toward the first elongate portion and the second sloped side portion sloping downward and away from the central hinge toward the second elongate portion; and, a first side hinge disposed between the first elongate portion and the foldable elongate portion and a second side hinge disposed between the second elongate portion and the foldable elongate portion, each of the first side hinge and the second side hinge extending the substantial length of the foldable elongate portion, where the horticultural tray is configured to collapse from an expanded configuration where the foldable elongate portion is in an unfolded arrangement and to a collapsed configuration where the foldable elongate portion is in a folded arrangement, a transverse extent of the foldable strip being greater in the unfolded arrangement than in the folded arrangement.

In particular embodiments of the method, the method comprises: providing a horticultural tray, the horticultural tray comprising, a first elongate portion and a second elongate portion each comprising one or more receptacles configured to receive and retain plant growing medium, each of the one or more receptacles extending from an opening arranged along a top side of the tray, each of the receptacles extending depthwise away from the top side and toward a bottom side of the tray; a foldable elongate portion disposed between the first elongate portion and the second elongate portion, the foldable elongate portion comprising: a central hinge disposed along a center length of the foldable elongate portion; and, a first sloped side portion disposed between the central hinge and the first elongate portion and a second sloped side portion disposed between the central hinge and the second storage receptacle strip, the first sloped side portion sloping downward and away from the central hinge toward the first storage receptacle strip and the second sloped side portion sloping downward and away from the central hinge toward the second storage receptacle strip; a first side hinge disposed between the first elongate portion and the foldable elongate portion and a second side hinge disposed between the second elongate portion and the foldable elongate portion, each of the first side hinge and the second side hinge extending the substantial length of the foldable strip, where the horticultural tray is configured to collapse from an expanded configuration where the foldable elongate portion is in an unfolded arrangement and to a collapsed configuration where the foldable elongate portion is in a folded arrangement, a transverse extent of the foldable strip being greater in the unfolded arrangement than in the folded arrangement; in the expanded arrangement, filling the one or more receptacles with a growing medium to a desired amount; and growing one or more plants within the one or more receptacles.

These and other aspects of the present invention are illustrated more fully in the drawings and in the exemplary embodiments described below.

### BRIEF DESCRIPTION OF THE DRAWINGS

FIG. 1 depicts one embodiment of a horticultural tray, in accordance with one or more aspects of the invention;

FIG. 2 depicts a longitudinal cross-sectional side view of the embodiment of the horticultural tray of FIG. 1, in accordance with one or more aspects of the invention;

FIG. 3 depicts a transverse cross-sectional side view of the embodiment of the horticultural tray of FIG. 1, in accordance with one or more aspects of the invention;

FIG. 4 depicts a close-up view of a portion of the cross-sectional view of FIG. 3, showing a part of a foldable elongate portion in detail in its unfolded configuration, in accordance with one or more aspects of the invention;

FIG. 5 depicts the foldable elongate portion of FIG. 4 in its collapsed or folded configuration, in accordance with one or more aspects of the invention;

FIG. 6 depicts an alternative configuration of a part of a foldable elongate portion in detail in its unfolded configuration, in accordance with one or more aspects of the invention;

FIG. 7 depicts the foldable elongate portion of FIG. 6 in its collapsed or folded configuration, in accordance with one or more aspects of the invention;

FIG. 8 depicts a close-up view of a portion of a horticultural tray from the bottom of the tray, in accordance with another embodiment of the invention;

FIG. 9 depicts a cross-sectional view of part of the portion of the horticultural tray of FIG. 8, in accordance with one or more aspects of the invention;

FIG. 10 depicts the view of the portion of the horticultural tray of FIG. 8 viewed from the top of the tray, in accordance with one or more aspects of the invention.

### DETAILED DESCRIPTION OF THE INVENTION

In general, a horticultural tray (which, as to the invention, refers to each of a standalone tray or a sheet insertable into a carrier tray or the like, unless specifically identified as one or the other) provides one or more elongate portions or “strips” that have rows of cells or receptacles for receiving a growing medium, such as soil or compost. Commonly, plants may be started as seedlings or cuttings from established plants in individual receptacles; as the plants begin to grow, the rows of receptacles must be separated to allow the plants more room to grow, and this is commonly accomplished by either cutting the elongate portions apart from one another, or by removing plants from certain rows and moving them into new pots or cells elsewhere. This process may be labor intensive. The elongate portions may have to be kept in a carrier tray if the strips lack structural strength to be handled individually or stand upright right unsupported during the growing process to allow even and healthy growth.

The present invention generally provides a horticultural tray with elongate portions or strips that have receptacles for holding growing medium and plants, and a foldable elongate portion with a central hinge that allows for folding the horticultural tray into a collapsed arrangement. When collapsed, the tray may easily be shipped, with or without growing medium and/or plants in the receptacles, and plants may be started in the tray while collapsed. When shipped, when the tray is a standalone tray, the tray includes sufficient structure to maintain structural integrity during the handling thereof. In other words, as a standalone tray, the tray is configured for use without a separate carrier tray. When the tray is an insert, for shipping, the tray is inserted into a carrier tray having sufficient structure for proper handling of the tray, as an insert. As plants are started or begin to grow, the foldable elongate portion may be unfolded into its expanded or unfolded arrangement, giving the plants the needed space to properly grow. This eliminates the need to cut strips apart, move plants out of their growing receptacles, and the need for a carrier tray. The foldable elongate portion has sloped side portions that slope downward toward the receptacles, so that as plants are watered from above, water that does not fall directly on the receptacles may be diverted by the sloped portions away from the central hinge and into the receptacles, allowing for more efficient use of water. While the receptacles may be filled with growing medium and/or seeds, seedlings, or cutting in the collapsed arrangement, in certain instances, the horticultural tray is at least partially filled with growing medium, such as by a soil machine, while in an expanded arrangement. Because the foldable elongate portion includes sloped side portions, any soil remaining between strips of receptacles in the expanded arrangement can be easily removed, such as by a brush, for example, since there are no recesses or depressions impeding removal thereof. In such instances, the tray remains in the expanded arrangement for growing plants.

Embodiments of the present invention include a horticultural tray with first and second elongate portions (“elongate receptacle portions”) and a foldable elongate portion arranged between the first and second elongate portions. It is appreciated that additional elongate portions and foldable elongate portions may be included in any such horticultural tray, where a pair of elongate portions each having one or more receptacles are separated by a foldable elongate portion. The first elongate portion and second elongate portion each have one or more receptacles configured to receive and retain plant growing medium or a pot. Each of the one or more receptacles extend from an opening arranged along a top side of the tray, and extending depthwise away from the top side and toward a bottom side of the tray. The tray can further be described such that the openings of the receptacles are arranged in an elongate body of the elongate strip, the body having a thickness defined by opposing top and bottom sides of the body, such that each receptacle extends from the body and an opening arranged in the body. It can be said, in certain instances, that if the receptacle openings are arranged along the top side, the receptacles are arranged along the bottom side of the elongate body. It is appreciated that the receptacles and receptacle openings may form any shape. It is also appreciated that the plurality of receptacles may be arranged in any manner along each of the first and second elongate portions. In certain embodiments, the one or more receptacles are arranged in a single row extending in a lengthwise direction along any first or second elongate portion, or the one or more receptacles are arranged in a plurality of rows along any first or second elongate portion. Optionally, in certain instances, between adjacent receptacles, a common watering channel, forming a recess along the top side of the body, may be optionally used to direct water flow between the adjacent receptacles. In doing so, the common watering channel extends from one receptacle to another receptacle along the top side of the body. Additionally, or separately, for any of the first or second elongate portion, a portion of the body adjacent to any receptacle is sloped along the top side to form a sloped recess, where the sloped recess is sloped downward into the receptacle to a direct water flow into the receptacle that would otherwise remain standing on the top side of the body. The sloped recess may at least partially or substantially bound one or more or all receptacles. The slope may comprise any angle relative the top side, and may remain constant for variable in the downward sloping direction or in any direction across the body.

The foldable elongate portion has a central hinge disposed along a center length of the foldable elongate portion. The central hinge generally divides the foldable elongate portion into two side portions, which may or may not be equal halves of the foldable elongate portion. The foldable elongate portion has a thickness formed by opposing top and bottom sides, the top side being arranged along a top side of the tray, just as is the top side of the first and second elongate portions, and the bottom side being arranged along a bottom side of the tray, just as is the bottom side of the first and second elongate portions. In certain instances, the central hinge: is a region of reduced thickness; comprises one or more scores extending at least partially or fully through the thickness of the tray or tray body; comprises one or a plurality of expandable or bendable folds extending lengthwise along the center length of the foldable elongate portion; or any combination thereof. It is appreciated that the central hinge may form of multiple hinges to form the central hinge.

It is appreciated that the region of reduced thickness may form a groove arranged along either or both opposing sides of the foldable elongate portion, the top and bottom sides of the foldable elongate portion. In lieu of a single groove, a plurality of grooves may be provided, the plurality of grooves being spaced apart along the central length such as to form an array of grooves. It is also appreciated that regions of reduced thickness may be wider than what would be commonly referred to as a groove. Regions of reduced thickness may be molded into the tray or may be formed into the tray after molding and curing of the tray has occurred. In forming grooves after molding and curing of the tray, the grooves may be formed by any known manner, such as by the application of force to form a depression, the removal of material, or by slicing partially through the thickness of the foldable elongate portion. Also, a region of reduced thickness may form a transition between different cross-sectional features of the tray, the transition forming a transition between an area of greater cross-sectional modulus (such as a stiffness modulus or bending modulus) to a location of lesser cross-sectional modulus (such as a stiffness modulus or bending modulus), the hinge operating along the area of lesser cross-sectional modulus.

Generally, the central hinge is arranged above a top side of the horticultural tray in the folded arrangement, opposite the bottom side of the horticultural tray. In other words, as the foldable elongate portion folds, the central hinge moves upward above the tops side of the tray with the side portions of the foldable elongate portion. In particular variations, the first and second side portions are sloped to provide a first sloped side portion disposed between the central hinge and the first elongate portion, and a second sloped side portion disposed between the central hinge and the second elongate portion. The first sloped side portion slopes downward and away from the central hinge toward the first elongate portion, and the second sloped side portion slopes downward and away from the central hinge toward the second elongate portion. It is appreciated that the slope of any sloped side portion may remain constant or is variable in the downward sloping direction of along the length of the foldable elongate portion. When the horticultural tray is in use for growing plants, the plants may be watered and water that falls on the sloped portions may be diverted toward the receptacles of the first and second elongate portions, along with any stray soil or other growing medium, thus conserving water and growing medium and keeping these materials away from the foldable central hinge. It is appreciated that for any first and second sloped side portion, the entire side portion does not need to be sloped, as a portion of each side portion may be sloped either partially or substantially. It is appreciated that, in certain embodiments, each of the first and second sloped side portion has a body akin to the body of any first or second elongate portion along which the receptacles are arranged. A first side hinge is disposed between and separates the first elongate portion and the foldable elongate portion and a second side hinge is disposed between and separates the second elongate portion and the foldable elongate portion. The first and second side hinges may take the form of any hinge use to form the central hinge, and generally extend the partial or substantial length of the foldable elongate portion. It is appreciated that each of the first and second side hinges may be spaced apart from any or all of the receptacles arranged along any first or second elongate portion, or may be arranged up to or in abutment with one or more of said receptacles. Likewise, it is also appreciated that each of the first and second side hinges may be spaced apart from an adjacent sloped side portion of a foldable elongate portion, or may be arranged up to or in abutment with any such adjacent sloped side portion. In certain instances, the first side hinge and second side hinge extend substantially parallel to the central hinge, but this may not be necessary as non-parallel arrangements are contemplated.

The horticultural tray is thus configured to collapse from an expanded configuration where the foldable elongate portion is in an unfolded arrangement and to a collapsed configuration where the foldable elongate portion is in a folded arrangement, where a transverse extent of the foldable strip is greater in the unfolded arrangement than in the folded arrangement.

The horticultural tray may also include a first locking tab extending downward below the first sloped side portion and a second locking tab extending upward above the second sloped side portion, so that the first locking tab is configured to securely fit inside the second locking tab when the at least one foldable strip is folded along the central hinge and the horticultural tray is in the collapsed configuration. The first and second locking tabs can be described as mating pairs of tabs, where on tab is insertable within the other tab and when inserted, resists removal due to the tight fit between the two tabs. The first and second locking tabs keep the tray in the collapsed configuration, and may be pulled apart or unlocked to expand the tray into the expanded or unfolded configuration. It is appreciated that additional first and second locking tabs may be employed to better maintain the foldable elongate portion in a folded configuration, recognizing that different quantities of locking tabs may be employed depending on the shape, size, and type of tray. It is also appreciated that any pair of first and second locking tabs may form any desired shape and size. In particular instances, the first and second locking tabs are arranged along the body of the respective first or second sloped side, although other arrangements are contemplated. The horticultural tray may thus be used both in a collapsed configuration for shipping purposes and, in some cases, to protect plants within receptacles during shipment, where the folded foldable elongate portion projects upward from the tray body to protect the plants. In certain instances, the tray is arranged in the expanded configuration initially for an entire growing period. In other instances, the tray is initially kept locked in the collapsed configuration as plants begin to grow, and then unlocked and expanded to more easily allow spatial expansion for the plants as they grow. After the plants have been removed and transplanted, the tray can be collapsed and locked again, ready to be re-used. It appreciated that a plurality of trays may be connected during any stage of using the trays, such as during any filling with growing medium, growing, or shipping. In certain embodiments, to facilitate attachment of at least one or two trays to a particular tray, the trays include one or more first mating protrusions arranged on one widthwise or lengthwise side of the tray and at least one corresponding second mating recess arranged on the opposing widthwise or lengthwise side of the tray, where a corresponding first mating protrusion mates with a corresponding second mating recess of another tray, or vice versa, to permit the attachment of the other tray to the particular tray. It is appreciated that any two or more trays may be attached at any time for any desired purpose.

In certain instances, the horticultural tray has a plurality of elongate portions with one receptacle or a plurality of receptacles arranged along each the elongate portions, and one foldable elongate portion or a plurality of foldable elongate portions arranged between adjacent elongate portions. For example, a horticultural tray may have three elongate portions with receptacles, with two foldable elongate portions disposed between the three elongate portions. The horticultural tray may also be configured to be attached to another horticultural tray described herein in accordance with an embodiment of the invention, where at least one side of each tray has a sloped portion and hinge. The horticultural trays may be configured to attach via locking tabs, so that when the trays are in collapsed configurations the locking tab of one tray fits securely into the locking tab of the other tray. In addition to, or in the alternative to, using locking tabs in any embodiment, the tray may also utilize other methods and mechanisms for keeping the trays attached in collapsed configurations, such as, for example, adhesive, staples, clips, hook and loop fasteners, such as Velcro® for example, double-sided tape, heat staking, and/or welds, such as vibration welding, solvent welding, or heat welding.

The present invention, in another aspect, provides a method that includes providing a horticultural tray as generally described above, placing the tray in its expanded arrangement for receiving growing medium, such as within a soil machine, for example, to fill the receptacles with growing medium, filling the receptacles as desired with growing medium. If the tray is filled within a soil machine, debris, such as growing medium arranged along the expanded foldable elongate portion is removed, such as by brush, for example, and the tray is then removed from the horticultural tray from the soil machine. After placing a seed, seedling, or cutting into the growing medium within each receptacle, in the expanded configuration plants are grown. During the growing cycle, the plants are watered, and at least a portion of the water dispensed onto the expanded foldable elongate portion is directed into one or more of the receptacles, via the first or second sloped side portions. Once the plants are grown to a desire maturity, the tray is collapsed and the tray with plants shipped to a desired recipient for further processing. Other variations of such methods may be employed or practiced as discussed and contemplated above in other embodiments.

Particular exemplary embodiments of the trays discussed above will now be discussed with reference to the drawings filed herewith.

With reference to an exemplary embodiment shown in FIG. 1, a horticultural tray 100 is shown in its expanded or unfolded configuration. The horticultural tray 100 depicted has three elongate portions 110 (first, second, and third elongate portions) that include receptacles 111 and two foldable elongate portions 115 disposed between the three elongate portions 100; it may be understood that a horticultural tray 100 may have any desired number of elongate portions 110 and foldable elongate portions 115, and reference below will generally be to a first elongate portion 110, a second elongate portion 110, and a foldable elongate portion 115 without loss of generality. First elongate portion 110 and second elongate portion 110 each include one or more receptacles 111 arranged in a body 110B thereof configured to receive and retain plant growing medium, such as soil, compost, and so on. The body 110B is depicted as a thin sheet-like portion of each corresponding elongate portion. Foldable elongate portion 115 has a central hinge 150 disposed along a center length of the foldable elongate portion 115. Foldable elongate portion 115 also has a first sloped side 120 and a second sloped side 125; first sloped side 120 is disposed between central hinge 150 and the first elongate portion 110, and second sloped side 125 is disposed between central hinge 150 and second elongate portion 110. Foldable elongate portion 115 also has a first locking tab 130 and a second locking tab 135, as further described below in conjunction with FIG. 3.

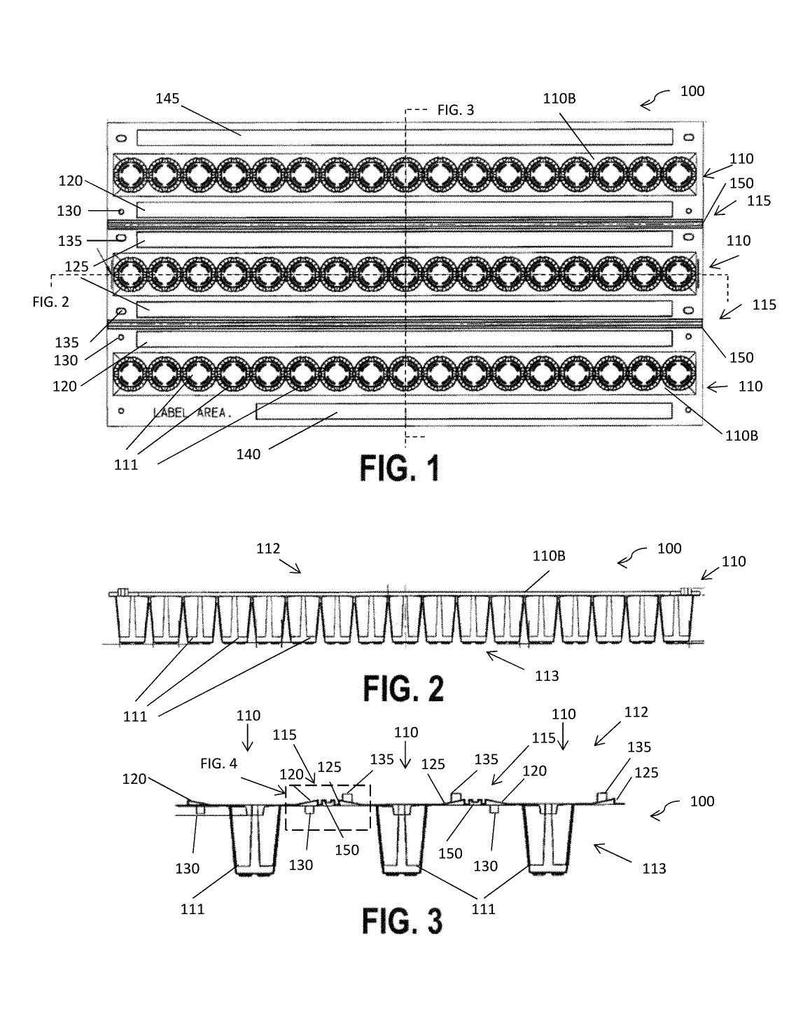

FIG. 2 depicts a cross-sectional side view of the horticultural tray 100 shown in FIG. 1, showing a longitudinal or lengthwise extension thereof. Receptacles 111 of elongate portion 110 extend from an opening arranged along a top side 112 of the tray of the body 110B, each of the receptacles extending depthwise away from the top side 112 and toward a bottom side 113 of the tray.

FIG. 3 depicts the embodiment of horticultural tray 100 shown in FIG. 1, showing a transverse or widthwise cross-section thereof. First sloped side portion 120 slopes downward and away from central hinge 150 towards the first elongate portion 110. Likewise, second sloped side portion 125 slopes downward and away from central hinge 150 toward second elongate portion 110. First locking tab 130 extends below first sloped side portion 120 and second locking tab 135 extends above second sloped side portion 125.

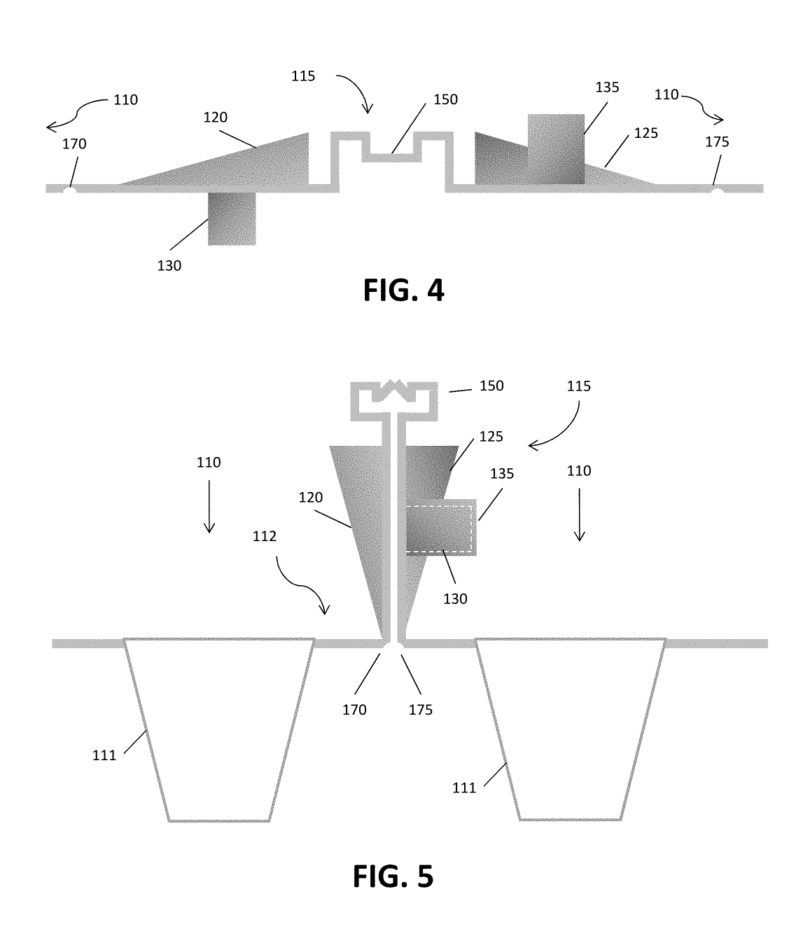

FIG. 4 shows a close-up view of part of foldable elongate portion 115 from FIG. 3 in its expanded or unfolded arrangement. In the embodiment shown in FIG. 4, central hinge 150 comprises a plurality of expandable or bendable folds arranged between first sloped side portion 120 and second sloped side portion 130. As FIG. 1 indicates, the plurality of expandable folds extend lengthwise along the center length of the foldable elongate portion 115. A first side hinge 170 is arranged between and separates first elongate portion 110 and foldable elongate portion 115 and a second side hinge 175 is arranged between and separates a second elongate portion 110 and foldable elongate portion 115. Each of the first and second side hinges 170, 175 extend the substantial length of the foldable elongate portion. One or both of first side hinge 170 and second side hinge 175 comprise a region of reduced thickness of the horticultural tray 100. In the example shown, the region of reduced thickness forms a depression or recess along a length of horticultural tray 100. In other examples, one or both of first side hinge 170 and second side hinge 175 may form one or more scores, or cuts, extending at least partially along a length of horticultural tray 100. The one or more scores may comprise a plurality of scores spaced apart along the length of the horticultural tray 100. Generally, first side hinge 170 and second side hinge 175 extend substantially parallel to central hinge 150.

FIG. 5 shows the close-up view of foldable elongate strip 115 of FIG. 4 in its collapsed or folded arrangement. As FIG. 5 shows, central hinge 150 is folded so it is arranged above the top side 112 of horticultural tray 100, opposite bottom side 113 of the horticultural tray 100. The first sloped side portion 120 and second sloped side portion 130 are collapsed together as central hinge 150 and first and second side hinges 170, 175 are folded, and first locking tab 130 is configured to securely fit inside second locking tab 135 when the foldable elongate portion 115 is folded along central hinge 150. First and second locking tabs 130, 135 thus secure the horticultural tray 100 in its collapsed position for shipping purposes and to conserve space. When needed, the first and second locking tabs 130, 135 may be uncoupled and foldable elongate portion 115 unfolded to expand the horticultural tray 100 into its unfolded configuration, as shown in FIGS. 1-4.

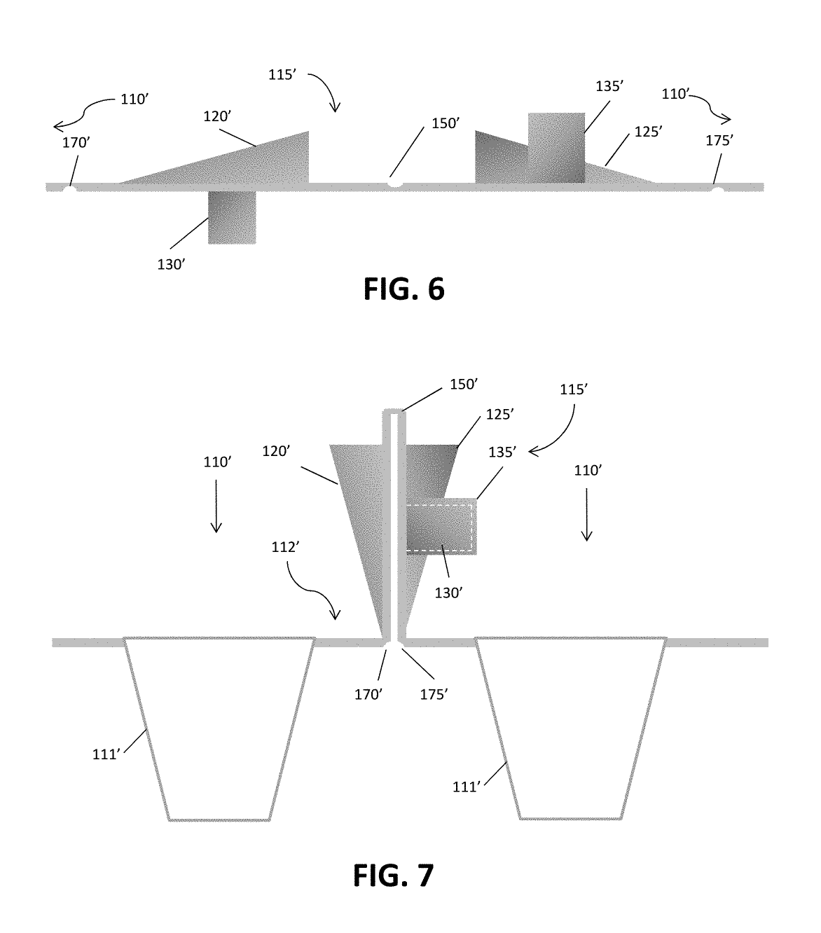

FIGS. 6 and 7 show an alternative embodiment of foldable elongate portion 115′ in which central hinge 150′, in one example, comprises a region of reduced thickness. The region of reduced thickness of central hinge 150′ forms a depression along a length of the horticultural tray 100, similar to first side hinge 170′ or second side hinge 175′. Alternatively, central hinge 150′ may form one or more scores, or cuts, extending at least partially along a length of horticultural tray 100. The one or more scores may comprise a plurality of scores spaced apart along the length of the horticultural tray 100, similar to first side hinge 170′ or second side hinge 175′. In any case, when central hinge 150′ is folded along with first and second side hinges 170′, 175′, first locking tab 130′ may fit securely inside second locking tab 135′ to keep the horticultural tray 100 in its collapsed arrangement, as previously described.

With reference to FIG. 1 again, horticultural tray 100 may be configured to be attached to another horticultural tray 100. At least one side of each horticultural tray 100 has a sloped portion 120, 125 at opposing transverse sides of the tray, as described above, where sloped portions 120, 125 facilitate diverting water toward receptacles 111 of elongate portions 110. Attaching may be accomplished, for instance, by locking tabs similar to locking tabs 130, 135 as described above, in a collapsed configuration, although in other variations, the connection may be made in an expanded configuration. For example, at least one side of horticultural tray 100 may have a first locking tab extending below the at least one side, and at least one side of another horticultural tray 100 may have a second locking tab extending above the at least one side. When the one horticultural tray 100 and the other horticultural tray are in a collapsed configuration, as described previously, the horticultural trays 100 may be attached via the first locking tab securely fitting inside the second locking tab. The horticultural trays may be attached for shipping purposes, or may be attached when growing several rows of similar plants together in one location. The horticultural trays may be expanded together and may be separated as desired.

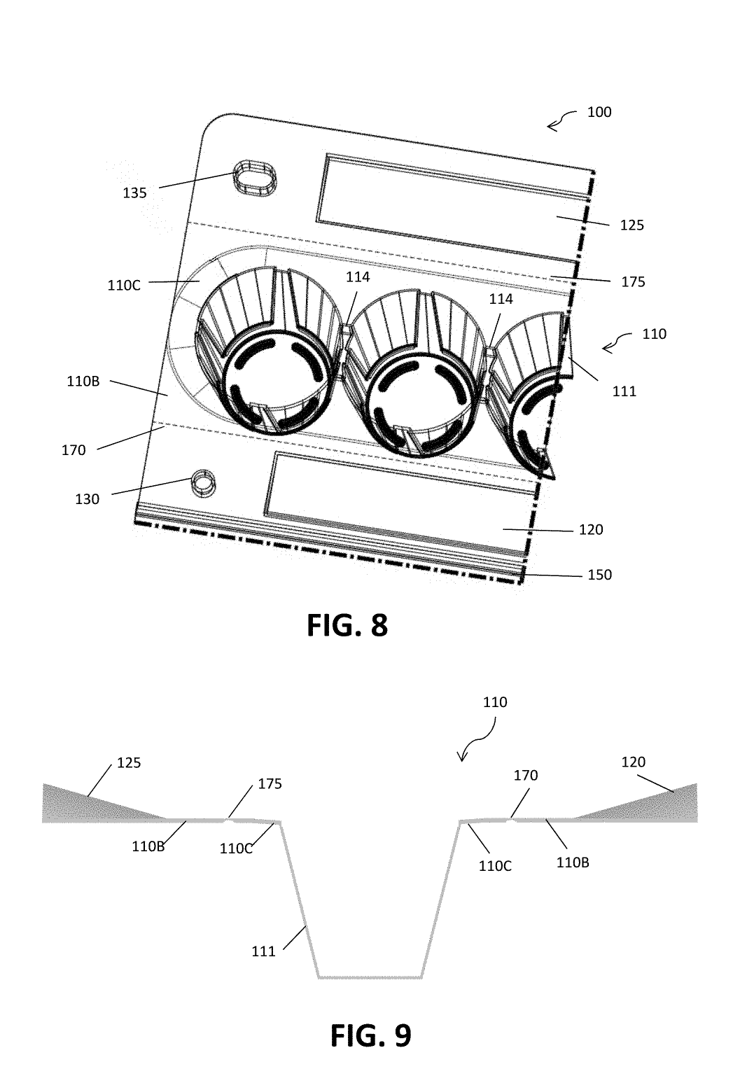

FIG. 8 depicts a portion of the horticultural tray 100 in accordance with a particular embodiment, from a bottom view perspective, showing receptacles 111 formed within body 110B of elongate portion 110. In this embodiment, one or more common watering channels 114 forming recesses are formed within body 110B between adjacent receptacles 111. Common watering channels 114 permit water to flow from one receptacle 111 to an adjacent receptacle 111, allowing for water sharing between receptacles 111 and helping to ensure that water does not accumulate in some receptacles while other receptacles lack water. Additionally, body 110B may have a sloped recess 110C that at least partially surrounds or bounds one or more of receptacles 111. As FIG. 8 shows, sloped recess 110C may substantially or almost entirely bound one or more of receptacles 111. As depicted in the cross-sectional view of FIG. 9, sloped recess 110C is sloped downward toward receptacles 111, similar to first sloped portion 120 and second sloped portion 125. It is further shown in this embodiment that the sloped recess 110C extends around a plurality of receptacles 111. During watering of one or more plants in receptacles 111, sloped recess 110C, similar to first sloped portion 120 and second sloped portion 125, diverts water falling on body 110B into receptacles 111, which helps maximize efficient use of water and minimize water otherwise wasted.

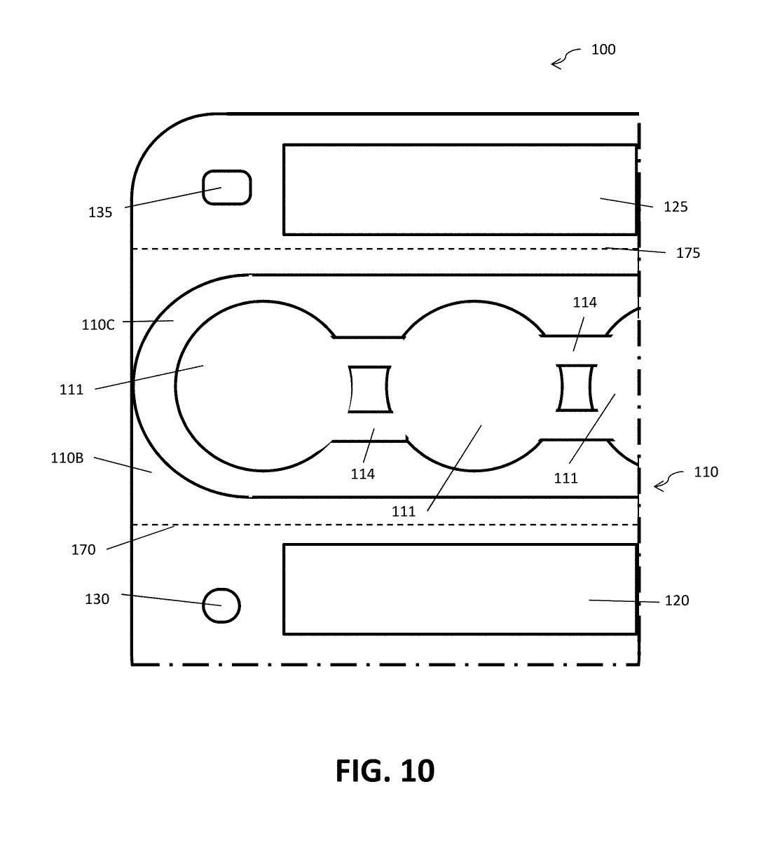

FIG. 10 shows the portion of the horticultural tray 100 of FIG. 8 from a top view perspective, showing more clearly the common watering channels 114 formed in body 110B that connect a pair of receptacles 111. As shown in the example of FIG. 10, two common watering channels 114 are disposed between each pair of adjacent receptacles 111; it may be readily understood that in alternative examples there may be one common watering channel 114 between adjacent receptacles 111, or there may be more than two common watering channels 114 between adjacent receptacles 111. It may be readily understood as well that horticultural trays 100, in alternative embodiments, may lack common watering channels 114 and/or may lack sloped recess 110C formed in body 110B.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the invention. Ranges that are described as being “between a and b” are inclusive of the values for “a” and “b” unless otherwise specified.

While this invention has been described with reference to particular embodiments thereof, it shall be understood that such description is by way of illustration only and should not be construed as limiting the scope of the claimed invention. Accordingly, the scope and content of the invention are to be defined only by the terms of the following claims. Furthermore, it is understood that the features of any specific embodiment discussed herein may be combined with one or more features of any one or more embodiments otherwise discussed or contemplated herein unless otherwise stated.

What is claimed is:

1. A horticultural tray comprising:
a first elongate portion and a second elongate portion each comprising one or more receptacles configured to receive and retain plant growing medium, each of the one or more receptacles extending from an opening arranged along a top side of the tray, each of the receptacles extending depthwise away from the top side and toward a bottom side of the tray;
a foldable elongate portion disposed between the first elongate portion and the second elongate portion, the foldable elongate portion comprising:
a central hinge disposed along a center length of the foldable elongate portion;
a first sloped side portion disposed between the central hinge and the first elongate portion and a second sloped side portion disposed between the central hinge and the second storage elongate portion, the first sloped side portion sloping downward and away from the central hinge toward the first elongate portion and the second sloped side portion sloping downward and away from the central hinge toward the second elongate portion; and,
a first side hinge disposed between the first elongate portion and the foldable elongate portion and a second side hinge disposed between the second elongate portion and the foldable elongate portion, each of the first side hinge and the second side hinge extending the substantial length of the foldable elongate portion, where the horticultural tray is configured to collapse from an expanded configuration where the foldable elongate portion is in an unfolded arrangement and to a collapsed configuration where the foldable elongate portion is in a folded arrangement, a transverse extent of the foldable strip being greater in the unfolded arrangement than in the folded arrangement.

2. The horticultural tray of claim 1 further comprising a first locking tab extending below the first sloped side portion and a second locking tab extending above the second sloped side portion, wherein the first locking tab is configured to securely fit inside the second locking tab when the foldable elongate portion is folded along the central hinge.

3. The horticultural tray of claim 1, where the central hinge is arranged above a top side of the horticultural tray in the folded arrangement, opposite the bottom side of the horticultural tray.

4. The horticultural tray of claim 1, where at least one of the central hinge, the first side hinge, and the second side hinge comprises a region of reduced thickness.

5. The horticultural tray of claim 4, where the region of reduced thickness forms a depression along a length of the horticultural tray.

6. The horticultural tray of claim 1, where at least one of the central hinge, the first side hinge, and the second side hinge forms one or more scores extending at least partially along a length of the horticultural tray.

7. The horticultural tray of claim 6, where the one or more scores comprise a plurality of scores spaced apart along the length of the horticultural tray.

8. The horticultural tray of claim 1, wherein the central hinge comprises a plurality of expandable folds arranged between the first and second sloped side portions and extending lengthwise along the center length of the foldable elongate portion.

9. The horticultural tray of claim 1, wherein the first side hinge and second side hinge extend substantially parallel to the central hinge.

10. The horticultural tray of claim 1, where the one or more receptacles form a plurality of receptacles in each of the first and second elongate portions.

11. The horticultural tray of claim 1, where the tray includes a plurality of foldable elongate portions and a plurality of storage receptacle elongate portions, the plurality of foldable elongate portions alternating with the plurality of storage receptacle elongate portions.

12. The horticultural tray of claim 1, where the horticultural tray is configured to be attached to another horticultural tray, and where at least one side of each tray has a sloped portion and hinge.

13. The horticultural tray of claim 12, where the at least one side of the horticultural tray has a first locking tab extending below the at least one side of the horticultural tray, the at least one side of the other horticultural tray has a second locking tab extending above the at least one side of the other horticultural tray, and wherein the horticultural tray and the other horticultural tray are configured to be attached when each horticultural tray is in a collapsed configuration via the first locking tab securely fitting inside the second locking tab.

14. The horticultural tray of claim 1, where the tray is a standalone tray, configured for use and handling without a carrier tray.

15. A method comprising:
providing a horticultural tray, the horticultural tray comprising
a first elongate portion and a second elongate portion each comprising one or more receptacles configured to receive and retain plant growing medium, each of the one or more receptacles extending from an opening arranged along a top side of the tray, each of the receptacles extending depthwise away from the top side and toward a bottom side of the tray;
a foldable elongate portion disposed between the first elongate portion and the second elongate portion, the foldable elongate portion comprising:
a central hinge disposed along a center length of the foldable elongate portion; and,
a first sloped side portion disposed between the central hinge and the first elongate portion and a second sloped side portion disposed between the central hinge and the second storage receptacle strip, the first sloped side portion sloping downward and away from the central hinge toward the first storage receptacle strip and the second sloped side portion sloping downward and away from the central hinge toward the second storage receptacle strip;
a first side hinge disposed between the first elongate portion and the foldable elongate portion and a second side hinge disposed between the second elongate portion and the foldable elongate portion, each of the first side hinge and the second side hinge extending the substantial length of the foldable strip, where the horticultural tray is configured to collapse from an expanded configuration where the foldable elongate portion is in an unfolded arrangement and to a collapsed configuration where the foldable elongate portion is in a folded arrangement, a transverse extent of the foldable strip being greater in the unfolded arrangement than in the folded arrangement;
placing the horticultural tray in the expanded arrangement and filling the one or more receptacles with a growing medium to a desired amount;
growing one or more plants within the one or more receptacles while the tray is in the expanded arrangement.

16. The method of claim 15 further comprising, during the step of growing one or more plants, watering the one or more plants, where water is dispensed along the top side of the horticultural tray, and where such water being dispensed along the foldable elongate portion in the expanded arrangement directs, via the first or second sloped side portions, at least a portion of the water being dispensed along the foldable elongate portion into the one or more receptacles.

17. The method of claim 15 further comprising removing debris from the foldable elongate portion in the expanded arrangement.

18. The method of claim 15, where the tray is a standalone tray, configured for use and handling without a carrier tray.
